(19) United States
(12) Patent Application Publication
(10) Pub. No.: US 2009/0249783 A1
(43) Pub. Date: Oct. 8, 2009

(54) Locomotive Engine Exhaust Gas Recirculation System and Method

(75) Inventors: Manoj Prakash Gokhale, Bangalore (IN); Bhaskar Tamma, Bangalore (IN); Chenna Krishna Rao Boyapati, Bangalore (IN)

Correspondence Address: GE TRANSPORTATION-RAIL;C/O FLETCHER YODER PC, P.O. BOX 692289, HOUSTON, TX, 77269-2289, US

(73) Assignee: GENERAL ELECTRIC COMPANY, Schenectady, NY (US)

(21) Appl. No.: 12/098,104

(22) Filed: Apr. 4, 2008

(51) Int. Cl. F02D 23/00

(52) U.S. Cl. 60/602; 60/605.2

(57) ABSTRACT

A system, in certain embodiments, includes a low pressure exhaust gas recirculation (EGR) system configure to route exhaust gas upstream of a compressor coupled to an intake of an engine in a low temperature environment. The system also includes a high pressure EGR system configure to route exhaust gas downstream of the compressor and upstream of the intake at a high altitude and/or in a low pressure environment. The system, in some embodiments, also may include a flow control configured to change flow of the exhaust gas of the low pressure and high pressure EGR systems based on operating limits and environmental conditions including temperature and pressure.

### BACKGROUND

The present technique relates generally to a system and method of operating a compression-ignition engine and, more specifically, to a system and method for controlling a diesel engine operated at extreme ambient conditions.

Compression-ignition engines, such as diesel engines, operate by directly injecting a fuel (e.g., diesel fuel) into compressed air in one or more piston-cylinder assemblies, such that the heat of the compressed air lights the fuel-air mixture. The direct fuel injection atomizes the fuel into droplets, which evaporate and mix with the compressed air in the combustion chambers of the piston-cylinder assemblies. Typically, compression-ignition engines operate at a relatively higher compression ratio than spark ignition engines. The compression ratio directly affects the engine performance, efficiency, exhaust pollutants, and other engine characteristics. In addition, the fuel-air ratio affects engine performance, efficiency, exhaust pollutants, and other engine characteristics. Exhaust emissions generally include pollutants such as carbon oxides (e.g., carbon monoxide), nitrogen oxides (NOx), unburnt hydrocarbons (HC), particulate matter (PM), and smoke. The amount and relative proportion of these pollutants varies according to the fuel-air mixture, compression ratio, injection timing, conditions of oxidizing air coming from atmosphere (i.e., atmospheric pressure, temperature, etc.), and so forth.

In certain applications, the compression-ignition engines are used in relatively extreme environmental conditions, such as high altitudes. For example, diesel powered locomotives can travel through a wide range of environmental conditions, particularly in mountainous regions. These environmental conditions can adversely affect engine performance, efficiency, exhaust pollutants, and other engine characteristics. For example, diesel engines operating in mountainous regions are subject to greater loads due to higher gradients, lower atmospheric pressures due to higher altitudes, lower temperatures due to colder climate or higher altitude, higher air density due to lower atmospheric temperature, and so forth.

The various engine parameters are particularly susceptible to exceed engine design limits when the engine is operating at a full load at extreme ambient temperature and/or altitude conditions. For example, these engine parameters may include in-cylinder peak firing pressure (PFP), pre-turbine temperature (PTT), and turbocharger speed (e.g., turbospeed). Also, engine operation at very high altitudes (e.g., greater than 4000 meters) and very low ambient temperatures (e.g., less than about −20 degrees Fahrenheit) causes the compressor of the turbocharger to operate in a choke region. A choke line often represents a threshold limit in the air flow rate or pressure ratio between the compressor inlet and exit due to design constraints in the size of inlets, outlets, passages, and so forth. This operation may result in failure of the engine power assembly and/or the turbocharger.

These engine parameters (e.g., PFP, PTT, turbocharger speed) should be maintained within design limits to avoid failure of the engine power assembly and turbocharger. Also, the compressor choke condition should be avoided to reduce the possibility of turbocharger failure. Typically, all of these problems are eliminated by derating the engine, i.e., reducing the power output of the engine. The reduction in power output can be achieved by reducing the fueling rate. This brings the PFP, PTT and turbocharger speed within design limits. Unfortunately, reducing the power output of the engine at higher altitudes results in a reduction in the hauling capacity of the engine. The engine deration also leads to an increase in fuel consumption.

### BRIEF DESCRIPTION

A system, in certain embodiments, includes a low pressure exhaust gas recirculation (EGR) system configure to route exhaust gas upstream of a compressor coupled to an intake of an engine in a low temperature environment. The system also includes a high pressure EGR system configure to route exhaust gas downstream of the compressor and upstream of the intake at a high altitude and/or in a low pressure environment. The system, in some embodiments, also may include a flow control configured to change flow of the exhaust gas of the low pressure and high pressure EGR systems based on operating limits and environmental conditions including temperature and pressure.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram illustrating a system having a low pressure (LP) exhaust gas recirculation (EGR) system coupled to a turbocharged engine in accordance with an embodiment of the present technique;

FIG. 2 is a block diagram illustrating a system having a high pressure (HP) exhaust gas recirculation (EGR) system coupled to a turbocharged engine in accordance with an embodiment of the present technique;

FIG. 3 is a block diagram illustrating a system having an adjustable exhaust gas recirculation (EGR) system having both a low pressure EGR system as illustrated in FIG. 1 and a high pressure EGR system as illustrated in FIG. 3 coupled to a turbocharged engine in accordance with another embodiment of the present technique; and

FIGS. 4-8 are flow charts illustrating various processes of operating a turbocharged engine in extreme ambient conditions in accordance with certain embodiments of the present technique.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As discussed in detail below, various configurations of exhaust gas recirculation (EGR) may be employed to reduce or eliminate power deration, reduce or improve specific fuel consumption (SFC), and maintain the various engine parameters within acceptable limits. For example, the embodiments discussed below may employ low pressure (LP) exhaust gas recirculation, high pressure (HP) exhaust gas recirculation, air preheating, or a combination thereof, relative to a compressor of a turbocharger coupled to an engine (e.g., a compression ignition engine). Specifically, the low pressure EGR introduces part of the engine exhaust upstream or into an intake of the compressor of the turbocharger coupled to the engine (i.e., on a low pressure side of the compressor). The high pressure EGR introduces part of the engine exhaust downstream of the compressor of the turbocharger coupled to the engine (i.e., on the high pressure side of the compressor). One or both of these types of EGR may be used depending on the atmospheric conditions. For example, the low pressure EGR may be used in low or high altitude environments with a low temperature, and the high pressure EGR may be used in high altitude environments with a low ambient pressure. By further example, the air preheating may be used alone or in combination with the low pressure EGR in low or high altitude environments with a low temperature. Thus, depending on the atmospheric conditions, a control system may employ the low pressure EGR, the high pressure EGR, air intake heating upstream of the compressor, or a combination thereof, to maintain engine operating parameters within acceptable limits without engine deration and with an improvement in the specific fuel consumption.

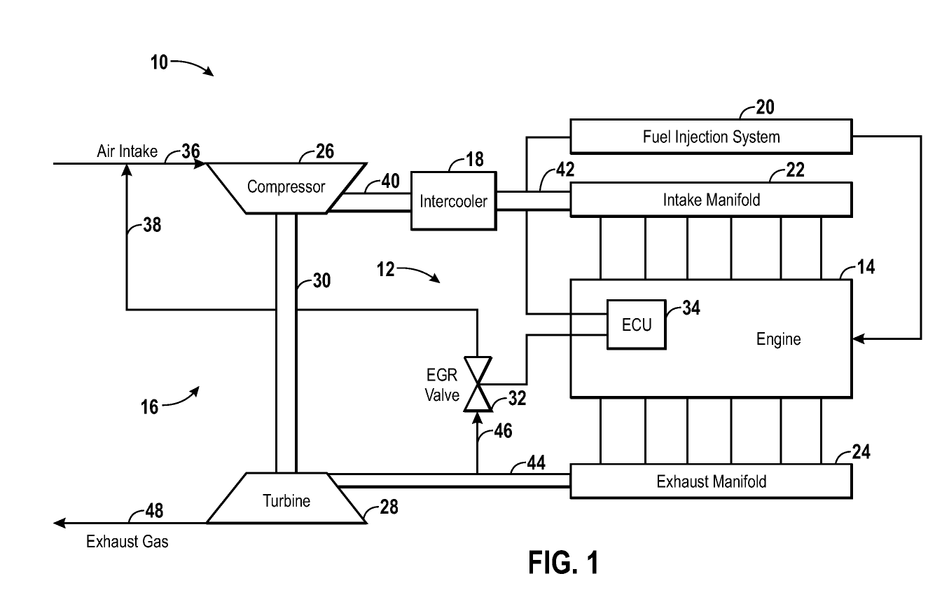

FIG. 1 is a block diagram of a system 10 having a low pressure (LP) exhaust gas recirculation (EGR) system 12 coupled to a turbocharged engine 14 in accordance with certain embodiments of the present technique. The system 10 may include a vehicle, such as a locomotive, an automobile, a bus, or a boat. Alternatively, the system 10 may include a stationary system, such as a power generation system having the engine 14 coupled to a generator. The illustrated engine 14 is a compression-ignition engine, such as a diesel engine. However, other embodiments of the engine 14 include a spark-ignition engine, such as a gasoline-powered internal combustion engine. In each of these embodiments, the EGR system 12 is configured to maintain engine operating parameters within acceptable limits without engine deration and with an improvement in the specific fuel consumption, particularly in a low temperature environment.

As illustrated, the system 10 includes a turbocharger 16, an intercooler 18, a fuel injection system 20, an intake manifold 22, and an exhaust manifold 24. The illustrated turbocharger 16 includes a compressor 26 coupled to a turbine 28 via a drive shaft 30. The low pressure EGR system 12 includes an EGR valve 32 disposed downstream from the exhaust manifold 24 and upstream from the compressor 26. In addition, the system 10 includes a controller 34, e.g., an electronic control unit (ECU), coupled to various sensors and devices throughout the system 10. For example, the illustrated controller 34 is coupled to the EGR valve 32 and the fuel injection system 20. However, the controller 34 may be coupled to sensors and control features of each illustrated component of the system 10 among many others. The sensors may include atmospheric and engine sensors, such as pressure sensors, temperature sensors, speed sensors, and so forth. For example, the sensors may include an atmospheric temperature sensor, an atmospheric pressure sensor, an atmospheric humidity sensor, and an altitude sensor. By further example, the sensors may include an engine air intake temperature, an engine air pressure intake pressure, an engine exhaust temperature sensor, and an engine exhaust pressure sensor. The sensors also may include compressor inlet and outlet sensors for temperature and pressure.

In the illustrated embodiment of FIG. 1, the system 10 intakes air into the compressor 26 as illustrated by arrow 36. In addition, as discussed further below, the compressor 26 may intake a portion of the exhaust from the exhaust manifold 24 via control of the EGR valve 32 as indicated by arrow 38. In turn, the compressor 26 compresses the intake air and the portion of the engine exhaust and outputs the compressed gas to the intercooler 18 via a conduit 40. The intercooler 18 functions as a heat exchanger to remove heat from the compressed gas as a result of the compression process. As appreciated, the compression process typically heats up the intake air and the portion of exhaust gas, and thus is cooled prior to intake into the intake manifold 22. As further illustrated, the compressed and cooled air passes from the intercooler 18 to the intake manifold 22 via conduit 42.

The intake manifold 22 then routes the compressed gas into the engine 14. The engine 14 then compresses this gas within various piston cylinder assemblies, e.g., 4, 6, 8, 10, 12, or 16 piston cylinder assemblies. Fuel from the fuel injection system 20 is injected directly into engine cylinders. The controller 34 may control the fuel injection timing of the fuel injection system 20, such that the fuel is injected at the appropriate time into the engine 14. The heat of the compressed air ignites the fuel as each piston compresses a volume within its corresponding cylinder.

In turn, the engine 14 exhausts the products of combustion from the various piston cylinder assemblies through the exhaust manifold 24. The exhaust from the engine 14 then passes through a conduit 44 from the exhaust manifold 24 to the turbine 28. In addition, a portion of the exhaust may be routed from the conduit 44 to the EGR valve 32 as illustrated by arrow 46. At this point, a portion of the exhaust passes to the air intake of the compressor 26 as illustrated by the arrow 38 as mentioned above. The controller 34 controls the EGR valve 32, such that a suitable portion of the exhaust is passed to the compressor 26 depending on various operating parameters and/or environmental conditions of the system 10. In addition, the exhaust gas drives the turbine 28, such that the turbine rotates the shaft 30 and drives the compressor 26. The exhaust gas then passes out of the system 10 and particularly the turbine 28 as indicated by arrow 48.

As mentioned above, the low pressure EGR system 12 of FIG. 1 may be employed in certain extreme environmental conditions to ensure that various engine parameters remain within acceptable limits without derating the engine and with an improvement in the specific fuel consumption (SFC). For example, at low atmospheric temperatures in either low or high altitude environments (e.g., low or high atmospheric pressures), the controller 34 may employ the EGR valve 32 to control (e.g., enable, disable, increase, or decrease) the amount of exhaust diverted from the conduit 44 to the intake of the compressor 26. In response to sensed low ambient temperatures and/or high peak firing pressures (PFP), the low pressure EGR system 12 may be employed to increase the temperature of the air intake entering the compressor 26. At low ambient temperature conditions, the density of the intake air is high leading to higher boost levels by the compressor 26 into the engine 14, which in turn increases the PFP. Typically, power deration is used to reduce the PFP down to the design limits. Unfortunately, the power deration reduces the hauling capacity of the engine 14 while also increasing specific fuel consumption (SFC). Instead of power deration, the illustrated embodiment of FIG. 1 utilizes the low pressure EGR 12 to increase the intake temperature into the compressor 26 via the hotter temperature of the exhaust, which in turn reduces the density of the intake gas into the compressor 26. As a result, the reduced density of the intake gas reduces the boost pressure of the compressor 26 and, thus, the PFP of the engine 14. Simultaneously, the exhaust gas diverted by the EGR valve 32 reduces the amount of exhaust gas passing to the turbine 28, thereby reducing the speed of the turbine 28 and also the driven compressor 26. As a result, the reduced speed of the turbocharger 16 also reduces the boost pressure of the compressor 26 and, thus the PFP of the engine 14.

For these reasons, the increased air temperature and reduced speed of the turbocharger 16 enables the engine 14 to operate at higher power levels or at least maintain the present power level. For these reasons, the low pressure EGR system 12 is able to reduce the PFP to a level within design limits, while also enabling the engine 14 to operate at the desired power (e.g., without engine deration) and with an improvement in the specific fuel consumption (SFC). In alternative embodiments, the heat provided by the exhaust passing through the EGR valve 32 to the intake of the compressor 26 may be supplemented or replaced with another form of heat exchanger or heater, thereby providing the desired heat to maintain the PFP within acceptable limits.

The illustrated low pressure EGR system 12 also may be used to substantially reduce or eliminate engine deration otherwise used to eliminate compressor choke at very high altitudes, such as a very low ambient pressure (e.g., 0.57 bar) and cold ambient temperatures (e.g., less than about minus twenty degrees Fahrenheit). For example, at low atmospheric pressures and low atmospheric temperatures, the controller 34 may employ the EGR valve 32 to control (e.g., enable, disable, increase, or decrease) the amount of exhaust diverted from the conduit 44 to the intake of the compressor 26. In response to sensed low ambient pressures and/or a choke condition in the turbocharger 16, the low pressure EGR system 12 may be employed to divert some of the exhaust gas away from the turbine 28 and increase the temperature of the air intake entering the compressor 26 to eliminate the choke condition. In certain embodiments, the compressor choke may correspond to a corrected turbocharger speed exceeding a critical limit. The corrected turbocharger speed may be defined as: turbocharger speed*[ambient temperature in degrees Kelvin/298]̂0.5.

In the illustrated embodiment, the EGR valve 32 adds the exhaust gas to the intake of the compressor 26 and/or heats the air intake of the compressor 26 to reduce the corrected turbocharger speed and help eliminate the choke condition. Again, as discussed above, by reducing the amount of exhaust gas passing to the turbine 28, the speed of the turbocharger 16 can be reduced to acceptable levels, while the diverted portion of the exhaust gas passes from the EGR valve 32 to the intake of the compressor 26 to heat and reduce the density of the intake air entering the compressor 26. For these reasons, the low pressure EGR system 12 is able to eliminate a choke condition, while also enabling the engine 14 to operate at the desired power (e.g., without engine deration) and with an improvement in the specific fuel consumption (SFC).

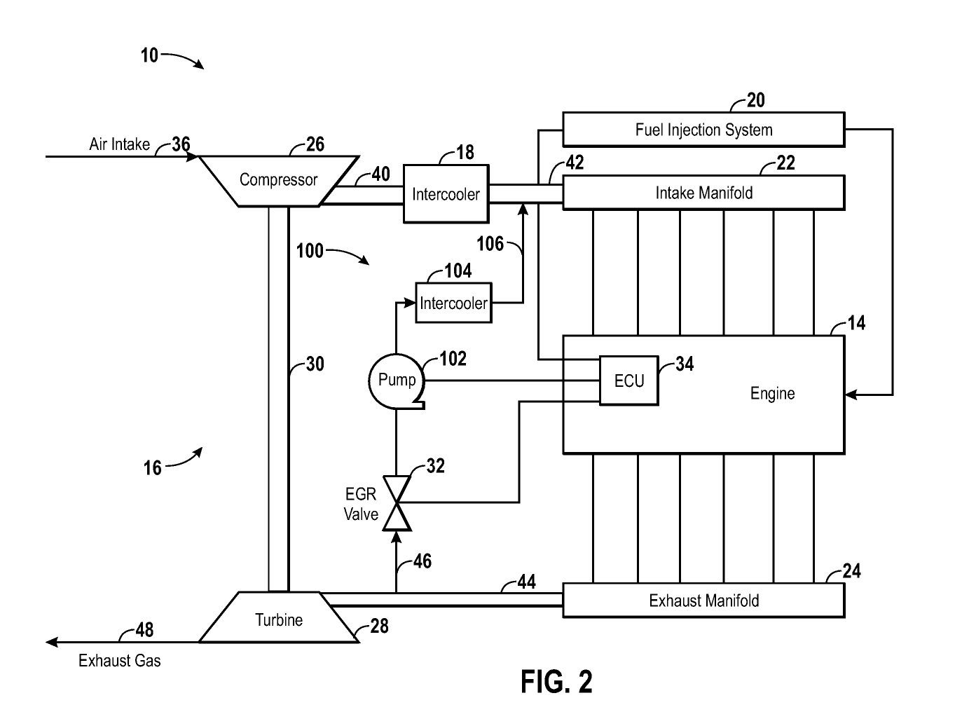

FIG. 2 is a block diagram of an alternative embodiment of the system 10 as illustrated in FIG. 1, wherein a high pressure (HP) exhaust gas recirculation (EGR) system 100 is coupled to the turbocharged engine 14. In this particular embodiment, the high pressure EGR system 100 includes the EGR valve 32, a pump 102, and an intercooler 104. In contrast to the low pressure EGR system 12 of FIG. 1, the high pressure EGR system 100 of FIG. 2 is coupled to a downstream side (i.e., high pressure side) of the compressor 26 rather than an upstream side (i.e., low pressure side). Specifically, the high pressure EGR system 100 diverts a portion of the exhaust gas from the exhaust manifold 24 to the conduit 42 between the intercooler 18 and the intake manifold 22. However, in general, the high pressure EGR system 100 differs from the low pressure EGR system 12 due to the fact that the compressor 26 has already compressed the intake air when the exhaust gas is introduced into the air flow passing to the engine 14.

Accordingly, as illustrated, the controller 34 may start, stop, or vary the EGR valve 32, such that exhaust gas recirculation starts, stops, or varies depending on various operating parameters and environmental conditions of the system 10. The pump 102 may be used to ensure sufficient pressure to flow the diverted exhaust gas from the valve 32 into the compressed gas downstream of the compressor 26. In other words, given that the intake air has been compressed to a higher pressure by the compressor 26, the pump 102 provides the pressure suitable to overcome the pressure differential and flow the exhaust gas into the intake manifold 22. In addition, the intercooler 104 may be used to reduce the temperature of the exhaust gas prior to entry into the intake manifold 22 as indicted by arrow 106.

As mentioned above, the high pressure EGR system 100 of FIG. 2 may be employed in high altitude and/or low atmospheric pressure conditions, where the density of the atmospheric air is relatively low. The low density of intake air tends to increase the speed of both the compressor 26 and the turbine 28, thereby potentially leading to over speeding the turbocharger 16. The high pressure EGR system 100 serves at least two functions to maintain the various engine operating parameters within acceptable limits. First, the high pressure EGR system 100 diverts a portion of the exhaust gas away from the turbocharger 16, such that less exhaust gas is available to drive the turbine 28 and in turn drive the compressor 26. In addition, the diverted portion of the exhaust gas passes into the intake manifold 22 downstream of the compressor 26, thereby adding both heat and pressure to the intake air entering the intake manifold 22. Specifically, the temperature of the exhaust gas adds at least some heat into the intake air entering the intake manifold 22, while the pump 102 at least maintains or adds pressure to the intake air entering the intake manifold 22. Although the intercooler 104 reduces the heat, the intercooler 104 may be selected or controlled to provide a desired temperature of the gases entering the intake manifold 22. For these reasons, the high pressure EGR system 100 is able to eliminate a choke condition, while also enabling the engine 14 to operate at the desired power (e.g., without engine deration) and with an improvement in the specific fuel consumption (SFC).

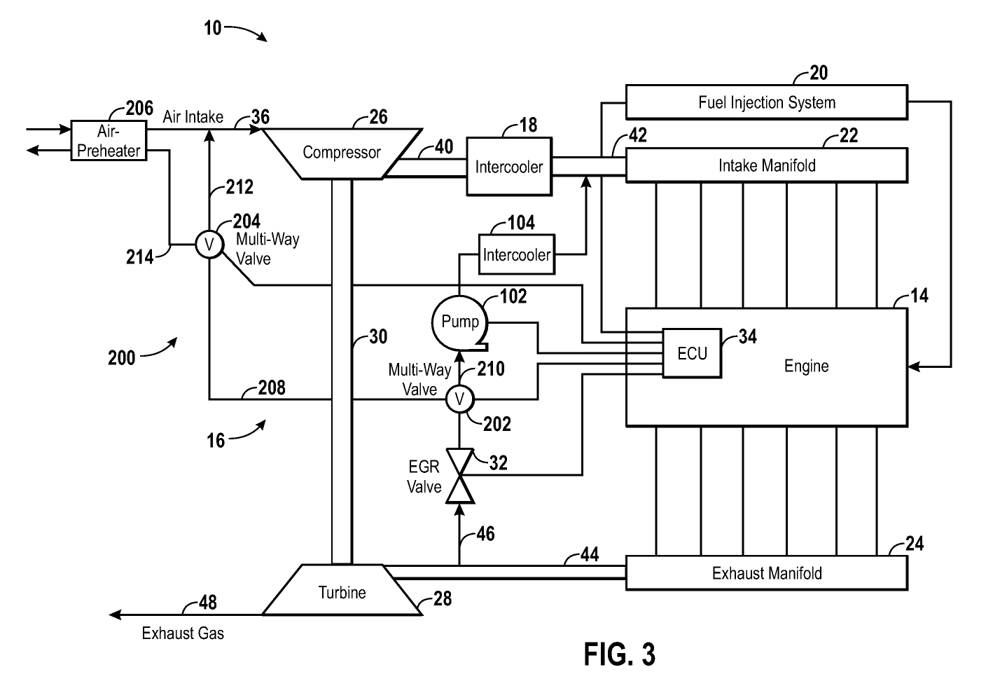

FIG. 3 is a block diagram of an alternative embodiment of the system 10 as illustrated in FIGS. 1 and 2, where a combination of the low pressure EGR system 12 of FIG. 1 and the high pressure EGR system 100 of FIG. 2 is coupled to the turbocharged engine 14. Specifically, the system 10 of FIG. 3 includes a variable low pressure, high pressure EGR system 200 having the EGR valve 32, the pump 102, the intercooler 104, a first multi-way valve 202 (e.g., 3-way valve), a second multi-way valve 204 (e.g., 3-way valve), and a pre-heater 206 (e.g., heat exchanger). The controller 34 varies the position of the valves 32, 202, and 204 to provide a suitable amount of exhaust gas recirculation and/or pre-heating of the air intake 36 depending on various engine operating parameters and environmental conditions. First, the EGR valve 32 controls the percentage or portion of exhaust gas that is diverted from the conduit 44 and turbine 28 to the upstream side of the intake manifold 22 (e.g., upstream or downstream of the compressor 26). Second, the valve 202 controls the percentage or portion of exhaust gas routed upstream (e.g., low pressure side) or downstream (e.g., high pressure side) of the compressor 26. Third, the valve 204 controls the percentage or portion of exhaust gas routed upstream of the compressor 26 or through the pre-heater 206 without entering the intake air 36.

In the illustrated embodiment, the multi-way valve 202 (e.g., 3-way valve) is controlled by the controller 34 to pass the exhaust gas to upstream and/or downstream sides of the compressor 26 as indicated by arrows 208 and 210. Thus, if the valve 202 is positioned to direct all of the exhaust gas from the EGR valve 32 to the downstream side of the compressor 26 as indicated by arrow 210, then the EGR system 200 functions as the high pressure EGR system 100 illustrated and described above with reference to FIG. 2. If the valve 202 is positioned to direct all of the exhaust gas from the EGR valve 32 to the upstream side of the compressor 26 as indicted by arrow 208, then the EGR system 200 may function identical or similar to the low pressure EGR system 12 of FIG. 1. For example, if the valve 204 is positioned to direct all of the exhaust gas from the valve 202 directly to the air intake 36 upstream of the compressor 26 as indicated by arrow 212, then the EGR system 200 functions identical to the low pressure EGR system 12 of FIG. 1. However, if the valve 204 is positioned to direct all or part of the exhaust gas into the pre-heater 206, then the EGR system 200 operates different from the EGR systems 12 and 100 of FIGS. 1 and 2.

For example, in low ambient temperature conditions, the controller 34 may adjust the valve 202 to route at least part or all of the exhaust gas from the EGR valve 32 to the valve 204. In turn, the controller 34 may adjust the valve 204 to route the exhaust gas directly into the compressor 26 without the pre-heater 206 as indicated by arrow 212 or the valve 204 may direct all or part of the exhaust gas into the pre-heater 206 as indicated by arrow 214. In some conditions, it is desirable to route the exhaust gas directly into the intake air 36 as indicated by arrow 212, for example, to provide greater NOx reduction. In other conditions, it is desirable to route the exhaust gas through the pre-heater 206 and out of the system 10 as indicated by arrow 214, for example, to provide some degree of heating while also venting the exhaust gas out of the system 10 rather than passing through the compressor 26 and the turbine 28.

The controller 34 adjusts the position of the valve 204 to vary the amount of pre-heating by the pre-heater 206 and direct exhaust gas directly into the compressor 26 based on various sensed parameters/conditions. In this manner, the controller 34 controls the intake temperature, which affects the intake density and boost pressure provided by the compressor 26 into the intake manifold 22. Given that low temperature air has a high density, the compressor 26 is able to provide a greater boost pressure with such low temperature, high density air. If the speed of the turbocharger 16 and/or the peak firing pressure (PFP) is exceeding or approaching design limits, then the valve 202 is adjusted to vary the ratio or portion of the exhaust gas passing to the upstream or low pressure side of the compressor 26. In turn, the valve 204 is varied to adjust whether the exhaust gas is passed directly into the intake air 36 or into the pre-heater 206 as indicated by arrows 212 and 214. In this manner, the air intake density can be reduced to reduce the pressure boost provided by the compressor 26, thereby reducing the PFP to a level within design limits.

Again, the EGR valve 32 is adjusted to vary a portion of the exhaust gas flowing or diverted from the conduit 44 away from the turbine 28, thereby reducing the speed of the turbine 28 and the driven compressor 26. Each of these elements 32, 202, and 204 can be adjusted to reduce the speed of the turbocharger 16, reduce the peak firing pressure (PFP), reduce the pre-turbine temperature (PTT), and eliminate a choke condition in response to extreme environmental conditions. In certain conditions, the EGR system 200 employs at least some low pressure EGR and high pressure EGR via the valves 202 and 204. Such a configuration may be desirable with environmental conditions not entirely suitable for one or the other of the two EGR systems as discussed in detail above with reference to FIGS. 1 and 2.

As discussed above, the EGR systems 12, 100, and 200 of FIGS. 1, 2, and 3 are configured to adjust operating parameters, such as peak firing pressure (PFP), turbocharger speed (e.g., turbine and/or compressor speed), and pre-turbine temperature (PTT), to levels within design limits or other preselected limits. Although these operating parameters can be maintained within limits by deration (e.g., reducing output power) of the engine 14, the disclosed embodiments maintain engine output power while also maintaining the parameters within limits. As shown below, Table 1 illustrates deration of the engine 14 as a function of ambient temperature (vertical axis) and ambient pressure (horizontal axis). Specifically, the data is shown as a percentage of maximum power (e.g., horsepower). The legend below Table 1 further illustrates that the deration may be associated with (or used to remedy) an excessive peak firing pressure (PFP), an excessive turbocharger speed, or an excessive pre-turbine temperature (PTT). In the presently disclosed embodiments, the low pressure EGR (e.g., 12) may be used in the portion of Table 1 labeled with double lines and associated with excessive peak firing pressure (PFP). The high pressure EGR (e.g., 100) may be used in the portion of Table 1 labeled with dashed lines and associated with excessive turbocharger speed. In addition, the high pressure EGR (e.g., 100) may be used in the portion of Table 1 labeled with a thick solid line (i.e., lower right corner) and associated with excessive turbocharger speed. Thus, Table 1 is a map of environmental temperature and pressure conditions in which each of the EGR systems may be employed in the presently disclosed embodiments. As shown, the different regions at least partially overlap with one another. In some applications, it may be desirable to use the LP EGR system 12 alone, the HP EGR system 100 alone, or both the LP and HP EGR systems in some combined EGR system 200.

TABLE 1

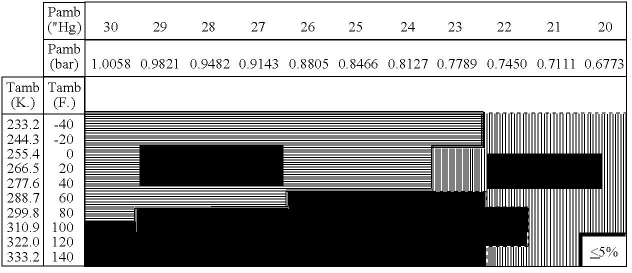

[symbol]

Deration due to Peak Firing Pressure (PFP) [symbol]
Deration due to Turbocharger Speed [symbol]
Deration due to Pre-Turbine Temperature (PTT)

In some embodiments, although Table 1 provides a good guide for the various operational limits and desired EGR, it may be desirable to employ either the LP EGR system 12 or the HP EGR system 100 (e.g., using EGR system 200) based on some specific ranges of environmental conditions and/or engine operating parameters. For example, LP EGR system 12 may be employed at low environmental temperatures of less than 40, 30, 20, 10, 0, −10, −20, −30, or some other temperature limit that is fixed or varies with other conditions, such as pressure. By further example, the LP EGR 12 may be employed for all ranges of environmental pressures at the foregoing environmental temperatures. However, in some embodiments, the HP EGR system 100 may be employed at lower environmental pressures and/or higher altitudes in combination or instead of the LP EGR system 12. For example, the HP EGR system 100 may be employed at high altitudes of greater than 2000 meters, 2500 meters, 3000 meters, 3500 meters, 4000 meters, 4500 meters, 5000 meters, or higher above sea level. Similarly, the HP EGR system 100 may be employed at low environmental pressures of less than 0.9 bar, 0.85 bar, 0.8 bar, 0.75 bar, 0.7 bar, 0.65 bar, 0.6 bar, or lower. These various environmental conditions may be employed alone or in combination with one another.

As discussed in further detail below, the low pressure EGR 12 of FIG. 1, the high pressure EGR 100 of FIG. 2, or the combined EGR 200 of FIG. 3 ensures that operating parameters stay within limits without the undesirable engine deration (e.g., reduction in power output) shown in Table 1. For example, Tables 2, 3, and 4 show the results of low pressure EGR and/or intake air pre-heating as shown in FIGS. 1 and 3. Specifically, Table 2 corresponds to environmental conditions of −40 degrees Fahrenheit atmospheric temperature and 1.0058 bar atmospheric pressure as shown in Table 1. Table 3 corresponds to environmental conditions of −40 degrees Fahrenheit atmospheric temperature and 0.7789 bar atmospheric pressure as shown in Table 1. Table 4 corresponds to environmental conditions of −40 degrees Fahrenheit atmospheric temperature and 0.6773 bar atmospheric pressure as shown in Table 1.

TABLE 2

| | % Power | | | |
|---|---|---|---|---|
| | (Actual/ | | % PFP | % SFC from |
| | Peak) | % EGR | (Actual/Limit) | derated condition |
| AS IS | 100.00% | 0.00% | 118.02% | |
| DERATION | 66.85% | 0.00% | 100.03% | 0.00% |
| LP EGR | 100.04% | 5.20% | 99.24% | −7.94% |
| PREHEAT | 100.01% | 0.00% | 100.50% | −8.10% |

TABLE 3

| | % Power | | % PFP | |
|---|---|---|---|---|
| | (Actual/Peak) | % EGR | (Actual/Limit) | % SFC |
| AS IS | 100.02% | 0.00% | 109.64% | |
| DERATION | 79.12% | 0.00% | 100.03% | 0.00% |
| LP EGR | 100.02% | 2.80% | 100.23% | −4.15% |
| PREHEAT | 100.03% | 0.00% | 100.08% | −4.14% |

TABLE 4

| | % Power | | % Turbospeed | |
|---|---|---|---|---|
| | (Actual/Peak) | % EGR | (Actual/Limit) | % SFC |
| AS IS | 100.00% | 0.00% | 1.04% | |
| DERATION | 83.78% | 0.00% | 1.00% | −8.43% |
| LP EGR | 100.03% | 3.50% | 0.98% | −15.82% |

As shown in Tables 2, 3, 4, the first row includes labels for the various columns of data, which include a percentage power (% Power) corresponding to a ratio of actual engine power output versus peak power output (e.g., actual/peak horsepower), a percentage of EGR diverted from the exhaust and turbine into the compressor (% EGR), a percentage peak firing pressure (PFP) corresponding to a ratio of actual PFP versus a PFP limit (Tables 2 and 3), a percentage turbospeed corresponding to a ratio of actual turbospeed versus a turbospeed limit (Table 4), and a percent reduction in specific fuel consumption (SFC) relative to the engine deration. The first column includes labels for the various rows of data, which include a) as is condition i.e. without any deration, EGR, or preheating (AS IS), b) engine deration (DERATION), c) low pressure exhaust gas recirculation (LP EGR) upstream of the compressor, and d) intake air preheating (PREHEAT) upstream of the compressor. As illustrated in each of the Tables 2, 3, and 4, the LP EGR and preheating maintain the engine power as compared to a drastic drop in engine power associated with derating the engine. In addition, the LP EGR and preheating provide a reduction in specific fuel consumption (SFC) as compared to the engine deration. Furthermore, the LP EGR and preheating provide a reduction in the peak firing pressure (PFP).

In addition, the LP EGR can limit the turbocharger speed to avoid a choke condition of the compressor, as illustrated in Table 5. The labels in Table 5 are identical to those shown in Tables 2, 3, and 4, with the addition of a corrected speed of the compressor in rpm. As discussed above, the corrected turbocharger speed may be defined as: turbocharger speed*[ambient temperature in degrees Kelvin/298]̂0.5. Table 5 corresponds to environmental conditions of −40 degrees Fahrenheit atmospheric temperature and 0.6773 bar atmospheric pressure as shown in Table 1. As illustrated, the LP EGR maintains the engine power as compared to a drastic drop in engine power associated with derating the engine. In addition, the LP EGR provides a reduction in specific fuel consumption (SFC) as compared to the engine deration. Furthermore, the LP EGR provides a reduction in the speed of the turbocharger, thereby avoiding a choke condition of the compressor.

TABLE 5

| | | | | % Corrected | |
|---|---|---|---|---|---|
| | % Power | | % Turbospeed | Turbospeed | |
| | (Actual/Peak) | % EGR | (Actual/Limit) | (Actual/Limit) | % SFC |
| AS IS | 100.00% | 0.00% | 104.18% | 110.79% | |
| DERATION | 62.53% | 0.00% | 94.16% | 100.12% | 0.00% |
| LP EGR | 100.03% | 3.50% | 97.93% | 99.37% | −15.82% |

Similarly, the following Table 6 shows the results of high pressure exhaust gas recirculation (HP EGR) as shown in FIGS. 2 and 3. Specifically, Table 6 corresponds to environmental conditions of 100 degrees Fahrenheit atmospheric temperature and 0.6773 bar atmospheric pressure as shown in Table 6. As illustrated, the HP EGR maintains the engine power as compared to a drastic drop in engine power associated with derating the engine. In addition, the HP EGR provides a reduction in specific fuel consumption (SFC) as compared to the engine deration. Furthermore, the HP EGR provides a reduction in the speed of the turbocharger, thereby avoiding a choke condition of the compressor.

TABLE 6

| | % Power | % Turbospeed | |
|---|---|---|---|
| | (Actual/Peak) | (Actual/Limit) | % SFC |
| AS IS | 100.08% | 102.12% | |
| DERATION | 91.32% | 100.00% | 0.0% |
| HP EGR | 100.10% | 100.01% | −1.5% |

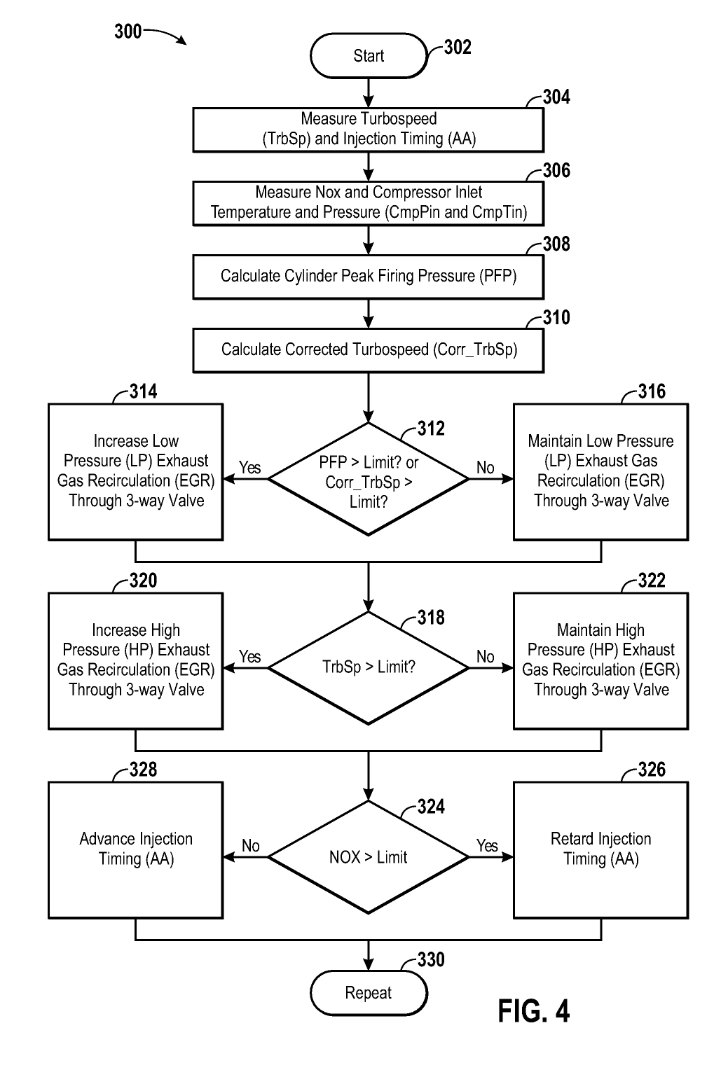

FIG. 4 is a flow chart of an exemplary engine exhaust gas recirculation (EGR) control process 300 in accordance with certain embodiments of the present technique. In the present embodiment, the process 300 is a computer-implemented method that may include various code or instructions stored on a computer-readable or machine readable medium, such as memory of a controller, a computer, a hard drive, or a computer disk. In turn, the code or instructions may be executable on a computer, such as a personal computer, a server, a vehicle computer, or an electronic control unit. As illustrated, the process 300 starts at block 302 and proceeds to measure the turbocharger speed (e.g., TrbSp) and injection timing (e.g., advancement angle or AA) of the engine at block 304. The process 300 then proceeds to measure the NOx and compressor inlet temperature and pressure (e.g., CmpPin and CmpTin) at block 306. In turn, the process 300 proceeds to calculate the cylinder peak firing pressure (PFP) at block 308. The process then calculates a corrected turbocharger speed (e.g., Corr_TrbSp) at block 310. The corrected turbocharger speed may be defined as: turbocharger speed [ambient temperature in degrees Kelvin/298]̂0.5.

In turn, the process 300 queries whether or not the peak firing pressure (PFP) is greater than a limit or whether the corrected turbocharger speed (Corr_TrbSp) is greater than a limit at block 312. These limits may correspond to pre-selected limits or design limits of the engine 14 and the turbocharger 16. If one of these limits is exceeded at block 312, then the process 300 proceeds to increase the low pressure (LP) exhaust gas recirculation (EGR) through a 3-way valve as indicated by block 314. For example, the process 300 may utilize the valve 202 as illustrated in FIG. 3. However, if neither of these limits is exceeded at block 312, then the process 300 proceeds to maintain the existing low pressure exhaust gas recirculation through the 3-way valve as indicated by block 316.

The process 300 then proceeds to another query block 318 to evaluate whether or not the turbocharger speed exceeds a limit. If the turbocharger speed exceeds the limit at block 318, then the process 300 proceeds to increase a high pressure (HP) exhaust gas recirculation (EGR) through a 3-way valve as indicated by block 320. Again, the process 300 may adjust the valve 202 as indicated in FIG. 3. However, if the turbocharger speed does not exceed the limit at block 318, then the process 300 may proceed to maintain an existing amount of high pressure exhaust gas recirculation through the 3-way valve as indicated by block 322.

Subsequently, the process 300 evaluates whether NOx levels exceed a limit at block 324. If the NOx level exceeds the limit at block 324, then the process 300 proceeds to retard the injection timing at block 326. However, if the NOx level does not exceed the limit at block 324, then the process 300 proceeds to advance the injection timing at block 328. For example, the process 300 may vary the advancement angle (AA) of the injection provided by the fuel injection system 20 of FIG. 3. The process 300 then proceeds to repeat the steps discussed above as indicated by block 330.

As illustrated by FIG. 4, the process 300 may vary the amount of the low pressure exhaust gas recirculation and/or the high pressure exhaust gas recirculation along with injection timing depending on whether or not operating limits are exceeded within the system 10. As discussed above, these various operating conditions are responsive to the environmental conditions. For example, at low ambient temperature conditions, the peak firing pressure (PFP) may exceed limits due to the higher density of the air being compressed by the compressor 26. Furthermore, at high ambient temperatures and low ambient pressures (e.g., high altitudes), the turbocharger speed may exceed limits due to the lower density of the air entering the compressor 26. In response to these conditions, the process 300 functions to reduce turbocharger speed to within acceptable limits and to reduce peak firing pressure to within acceptable limits by controlling various EGR systems and injection timing.

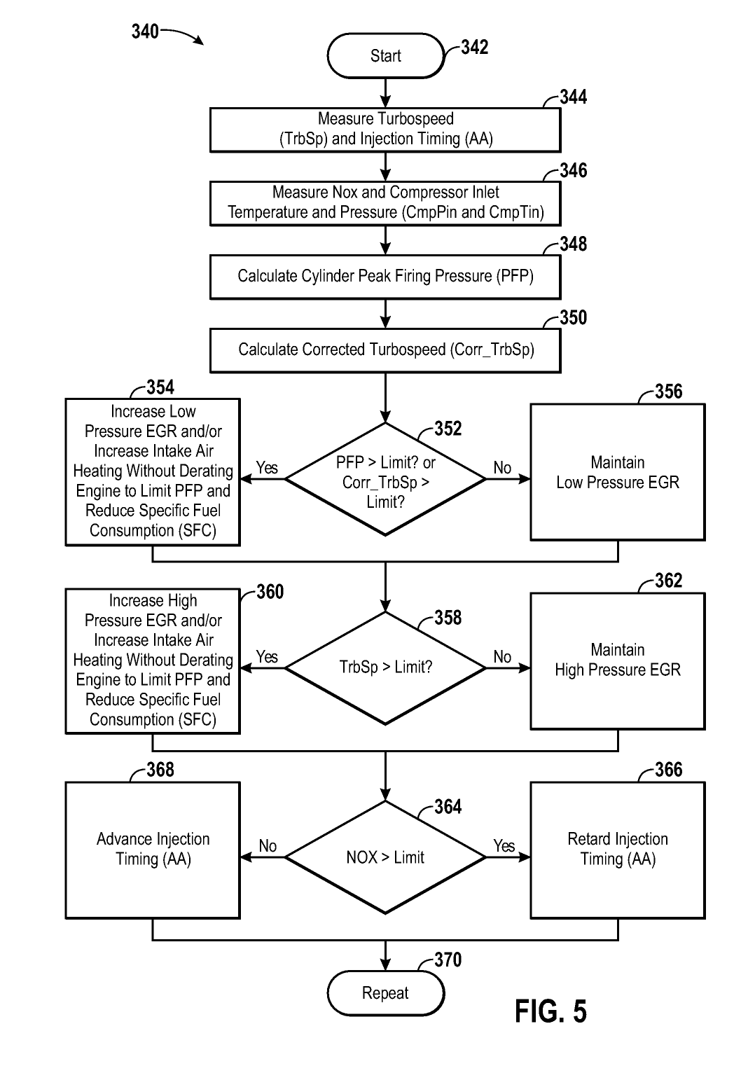

FIG. 5 is a flow chart of an exemplary engine exhaust gas recirculation (EGR) control process 340 in accordance with certain embodiments of the present technique. In the present embodiment, the process 340 is a computer-implemented method that may include various code or instructions stored on a computer-readable or machine readable medium, such as memory of a controller, a computer, a hard drive, or a computer disk. In turn, the code or instructions may be executable on a computer, such as a personal computer, a server, a vehicle computer, or an electronic control unit. As illustrated, the process 340 starts at block 342 and proceeds to measure the turbocharger speed (e.g., TrbSp) and injection timing (e.g., advancement angle or AA) of the engine at block 344. The process 340 then proceeds to measure the NOx and compressor inlet temperature and pressure (e.g., CmpPin and CmpTin) at block 346. In turn, the process 340 proceeds to calculate the cylinder peak firing pressure (PFP) at block 348. The process then calculates a corrected turbocharger speed (e.g., Corr_TrbSp) at block 350. The corrected turbocharger speed may be defined as: turbocharger speed [ambient temperature in degrees Kelvin/298]̂0.5.

In turn, the process 340 queries whether or not the peak firing pressure (PFP) is greater than a limit or whether the corrected turbocharger speed (Corr_TrbSp) is greater than a limit at block 352. These limits may correspond to pre-selected limits or design limits of the engine 14 and the turbocharger 16. If one of these limits is exceeded at block 352, then the process 340 proceeds to increase the low pressure (LP) exhaust gas recirculation (EGR) and/or increase intake air heating without derating the engine to limit peak firing pressure (PFP) and reduce specific fuel consumption (SFC) as indicted by block 354. For example, the process 340 may utilize the valves 32, 202, and 204 as illustrated in FIG. 3. However, if neither of these limits is exceeded at block 352, then the process 340 proceeds to maintain the existing low pressure exhaust gas recirculation as indicated by block 356.

The process 340 then proceeds to another query block 358 to evaluate whether or not the turbocharger speed exceeds a limit. If the turbocharger speed exceeds the limit at block 358, then the process 340 proceeds to increase a high pressure (HP) exhaust gas recirculation (EGR) and/or increase intake air heating without derating the engine to limit peak firing pressure (PFP) and reduce specific fuel consumption (SFC) as indicated by block 360. Again, the process 340 may adjust the valves 32, 202, and 204 as indicated in FIG. 3. However, if the turbocharger speed does not exceed the limit at block 358, then the process 340 may proceed to maintain an existing amount of high pressure exhaust gas recirculation as indicated by block 362.

Subsequently, the process 340 evaluates whether NOx levels exceed a limit at block 364. If the NOx level exceeds the limit at block 364, then the process 340 proceeds to retard the injection timing at block 366. However, if the NOx level does not exceed the limit at block 364, then the process 340 proceeds to advance the injection timing at block 368. For example, the process 340 may vary the advancement angle (AA) of the injection provided by the fuel injection system 20 of FIG. 3. The process 340 then proceeds to repeat the steps discussed above as indicated by block 370.

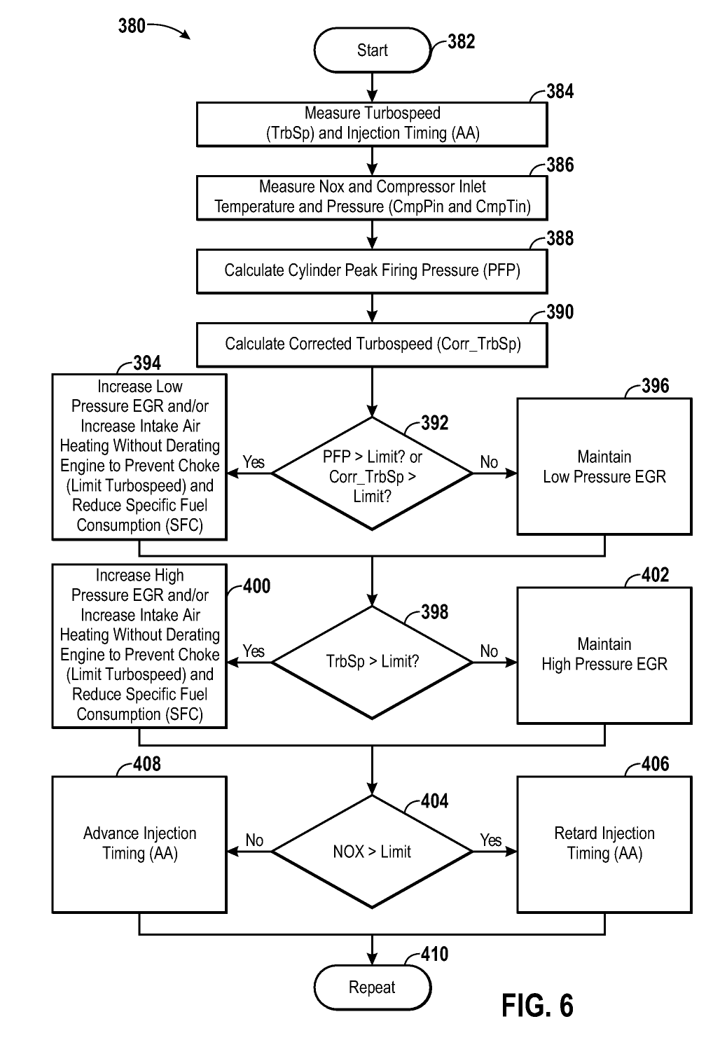

FIG. 6 is a flow chart of an exemplary engine exhaust gas recirculation (EGR) control process 380 in accordance with certain embodiments of the present technique. In the present embodiment, the process 380 is a computer-implemented method that may include various code or instructions stored on a computer-readable or machine readable medium, such as memory of a controller, a computer, a hard drive, or a computer disk. In turn, the code or instructions may be executable on a computer, such as a personal computer, a server, a vehicle computer, or an electronic control unit. As illustrated, the process 380 starts at block 382 and proceeds to measure the turbocharger speed (e.g., TrbSp) and injection timing (e.g., advancement angle or AA) of the engine at block 384. The process 380 then proceeds to measure the NOx and compressor inlet temperature and pressure (e.g., CmpPin and CmpTin) at block 386. In turn, the process 380 proceeds to calculate the cylinder peak firing pressure (PFP) at block 388. The process then calculates a corrected turbocharger speed (e.g., Corr_TrbSp) at block 390. The corrected turbocharger speed may be defined as: turbocharger speed [ambient temperature in degrees Kelvin/298]̂0.5.

In turn, the process 380 queries whether or not the peak firing pressure (PFP) is greater than a limit or whether the corrected turbocharger speed (Corr_TrbSp) is greater than a limit at block 392. These limits may correspond to pre-selected limits or design limits of the engine 14 and the turbocharger 16. If one of these limits is exceeded at block 392, then the process 380 proceeds to increase the low pressure (LP) exhaust gas recirculation (EGR) and/or increase intake air heating without derating the engine to prevent a choke condition (e.g., limit speed of the turbocharger) and reduce specific fuel consumption (SFC) as indicted by block 394. For example, the process 380 may utilize the valves 32, 202, and 204 as illustrated in FIG. 3. However, if neither of these limits is exceeded at block 392, then the process 380 proceeds to maintain the existing low pressure exhaust gas recirculation as indicated by block 396.

The process 380 then proceeds to another query block 398 to evaluate whether or not the turbocharger speed exceeds a limit. If the turbocharger speed exceeds the limit at block 398, then the process 380 proceeds to increase a high pressure (HP) exhaust gas recirculation (EGR) and/or increase intake air heating without derating the engine to prevent a choke condition (e.g., limit speed of the turbocharger) and reduce specific fuel consumption (SFC) as indicated by block 400. Again, the process 380 may adjust the valves 32, 202, and 204 as indicated in FIG. 3. However, if the turbocharger speed does not exceed the limit at block 398, then the process 380 may proceed to maintain an existing amount of high pressure exhaust gas recirculation as indicated by block 402.

Subsequently, the process 380 evaluates whether NOx levels exceed a limit at block 404. If the NOx level exceeds the limit at block 404, then the process 380 proceeds to retard the injection timing at block 406. However, if the NOx level does not exceed the limit at block 404, then the process 380 proceeds to advance the injection timing at block 408. For example, the process 380 may vary the advancement angle (AA) of the injection provided by the fuel injection system 20 of FIG. 3. The process 380 then proceeds to repeat the steps discussed above as indicated by block 410.

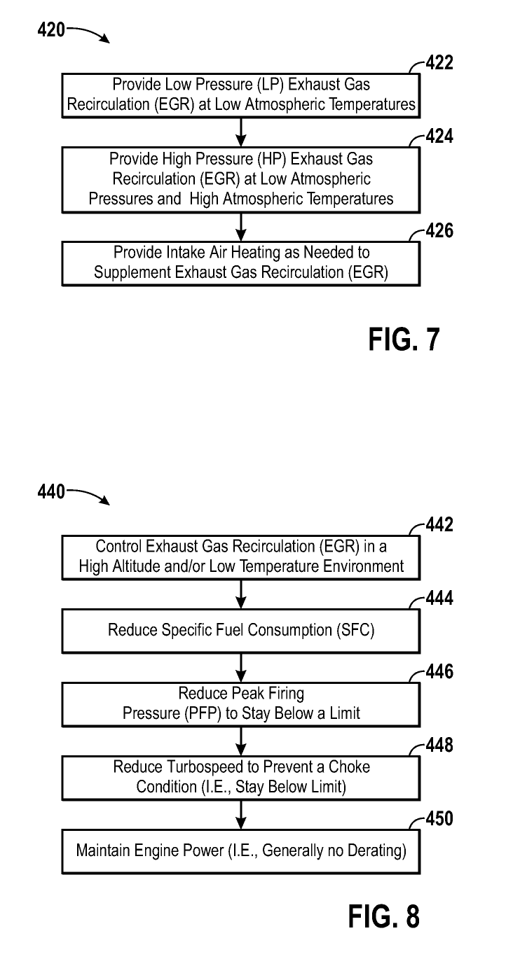

FIG. 7 is a flowchart of another embodiment of an engine exhaust gas recirculation (EGR) control process 420. As illustrated, the process 420 provides a low pressure (LP) exhaust gas recirculation (EGR) at low atmospheric temperatures at block 422. As discussed above, the low atmospheric temperatures may correspond to freezing temperatures, such as those found in high altitude environments. For example, the low atmospheric temperatures may be below zero degrees Fahrenheit (e.g., less than minus twenty degrees Fahrenheit). Furthermore, the process 420 may utilize the low pressure EGR system 12 as illustrated in FIG. 1 or a portion of the EGR system 200 as illustrated in FIG. 3 for the step 422. In turn, the process 420 provides a high pressure (HP) exhaust gas recirculation (EGR) at low atmospheric pressures and high atmospheric temperatures as indicated by block 424. Again, the process 420 may utilize the high pressure EGR system 100 as shown in FIG. 2 or a similar portion of the EGR system 200 as shown in FIG. 3. The low atmospheric pressure may correspond to a high altitude environment such as one typical of mountainous regions. By further example, the low atmospheric pressures may be at altitudes of greater than 4,000 meters, e.g., less than about 0.75 bar atmospheric pressure. The high atmospheric temperatures may correspond to temperatures above zero degrees Fahrenheit as compared to below zero temperatures typical of those used with low pressure EGR of step 422. The process 420 also may provide intake air heating as needed or desired with the exhaust gas recirculation (EGR) as indicated by block 426. Again, the process 420 may utilize the pre-heater 206 as shown in FIG. 3, thereby increasing the temperature and density of the intake air to reduce the pressure boost and peak firing pressure of the engine.

FIG. 8 is another alternative engine exhaust gas recirculation (EGR) control process 440 that may be used in conjunction with one of the systems shown in FIGS. 1-3. As illustrated, the process 440 includes control of exhaust gas recirculation (EGR) in a high altitude and/or a low temperature environment as indicated by block 442. As discussed above, the high altitude environment may correspond to a mountainous region such as above 4,000 meters. The low temperature environment may correspond to temperatures below freezing, below zero degrees Fahrenheit, or even below −20 degrees Fahrenheit. The high altitude environment also may correspond to both a low pressure and low temperature environment. For example, the low pressure environment may be at pressures below one bar ambient pressure. For example, the pressures may fall below 0.9 bar, 0.8 bar, 0.7 bar, or 0.6 bar depending on the elevation. Based on these various environmental conditions, the process 440 adjusts the amount of the exhaust gas recirculation to maintain various operating parameters below design limits to maintain or improve the performance of the engine.

For example, as illustrated in FIG. 8, the process 440 includes reducing specific fuel consumption (SFC) as indicated by block 444. The process 440 also includes reducing the peak firing pressure (PFP) to stay below a limit of an engine as indicated by block 446. The process 440 also includes reducing a turbocharger speed to prevent a choke condition by staying below a limit as indicated by block 448. The process 440 further includes maintaining an engine power rather than derating the engine as indicted by block 450. These steps of the process 440 may achieved by the EGR systems 12, 100, and 200 as shown and described above with reference to FIGS. 1-3.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a low pressure exhaust gas recirculation (EGR) system configured to route exhaust gas upstream of a compressor coupled to an intake of an engine in a low temperature environment; and
a high pressure EGR system configured to route exhaust gas downstream of the compressor and upstream of the intake of the engine at a high altitude and/or in a low pressure environment.

2. The system of claim 1, comprising a flow control configured to change flow of the exhaust gas of the low pressure and high pressure EGR systems based on operating limits and environmental conditions including temperature and pressure.

3. The system of claim 1, wherein the low pressure EGR system and/or the high pressure EGR system are configured to maintain operational parameters within limits without deration of the engine, and the operational parameters comprise a peak firing pressure, a turbocharger speed of a turbocharger having a turbine coupled to the compressor, and a pre-turbine temperature of the turbine.

4. The system of claim 1, wherein the low pressure EGR system is configured to increase a temperature and reduce a density of intake air entering the compressor.

5. The system of claim 4, wherein the low pressure EGR system is configured to reduce a peak firing pressure of the engine to a level below a limit.

6. The system of claim 4, wherein the low pressure EGR system is configured to reduce a speed of the compressor to a level below a choke condition.

7. The system of claim 1, wherein the high pressure EGR system is configured to reduce a speed of the compressor to a level below a choke condition.

8. The system of claim 1, wherein the low temperature environment comprises temperatures at least below about 40 degrees Fahrenheit, the high altitude comprises altitudes at least greater than about 2000 meters, and the low pressure environment comprises pressures at least below about 0.85 bar.

9. A system, comprising:
a flow control configured to change flow of an exhaust gas into a low pressure side upstream of a compressor coupled to an intake of an engine, through a pre-heater on the low pressure side of the compressor, and into a high pressure side downstream of the compressor, wherein the flow control is responsive to environmental temperature and environmental pressure and/or altitude to maintain a peak firing pressure and a speed of the compressor within limits.

10. The system of claim 9, wherein the flow control comprises a valve and a controller coupled to the valve.

11. The system of claim 10, wherein the flow control comprises an electronic control unit.

12. The system of claim 9, wherein the flow control is configured to route the exhaust gas at least partially into the low pressure side and/or through the pre-heater to increase an intake temperature of the compressor in a low temperature environment.

13. The system of claim 12, wherein the flow control is configured to route the exhaust gas at least partially into the low pressure side and/or through the pre-heater to reduce the peak firing pressure of the engine to a level below a limit.

14. The system of claim 12, wherein the flow control is configured to route the exhaust gas at least partially into the low pressure side and/or through the pre-heater to reduce the speed of the compressor to a level below a choke condition.

15. The system of claim 9, wherein the flow control is configured to route the exhaust gas at least partially into the high pressure side at a high altitude and/or a low pressure environment.

16. The system of claim 15, wherein the flow control is configured to route the exhaust gas at least partially through the high pressure side to reduce the speed of the compressor to a level below a choke condition.

17. A method, comprising:
routing exhaust gas upstream of a compressor coupled to an intake of an engine in a low temperature environment; and
routing exhaust gas downstream of the compressor and upstream of the intake at a high altitude and/or in a low pressure environment.

18. The method of claim 17, wherein routing exhaust gas upstream and/or downstream comprises maintaining within limits a peak firing pressure, a turbocharger speed of a turbocharger having a turbine coupled to the compressor, and a pre-turbine temperature of the turbine.

19. The method of claim 17, wherein routing the exhaust gas upstream comprises increasing a temperature and reducing a density of intake air entering the compressor, and reducing exhaust gas flow through a turbine coupled to the compressor.

20. The method of claim 19, wherein increasing the temperature and reducing the density comprises reducing a pressure boost by the compressor and reducing a peak firing pressure of the engine, and reducing exhaust gas flow through the turbine comprises reducing a speed of the compressor.

21. The method of claim 17, wherein routing the exhaust gas downstream comprises reducing exhaust gas flow through a turbine coupled to the compressor to reduce a speed of the compressor.

22. A system, comprising:
a low pressure exhaust gas recirculation (EGR) system configure to route exhaust gas upstream of a compressor coupled to an intake of an engine in a low temperature environment, wherein the low pressure EGR system is configured to increase a temperature and reduce a density of intake air due to the low temperature environment, the low pressure EGR system is configured to reduce a peak firing pressure to a level within a limit, the low pressure EGR system is configured to reduce a speed of the compressor to a level below a choke condition, the low pressure EGR system is configured to reduce specific fuel consumption, and the low pressure EGR system is configured to maintain engine power.

23. The system of claim 22, comprising a control configured to initiate the low pressure EGR in response to the low temperature environment, wherein the low temperature environment comprises a temperature less than about 40 degrees Fahrenheit.

24. A system, comprising:
a high pressure exhaust gas recirculation (EGR) system configure to route exhaust gas downstream of a compressor coupled to an intake of an engine at a high altitude and/or in a low pressure environment, wherein the high pressure EGR system is configured to increase flow to the intake of the engine, the high pressure EGR system is configured to reduce a speed of the compressor to a level below a choke condition, the low pressure EGR system is configured to reduce specific fuel consumption, and the low pressure EGR system is configured to maintain engine power.

25. The system of claim 24, comprising a control configured to initiate the high pressure EGR in response to the high altitude and/or the low pressure environment, wherein the high altitude is at least greater than about 2000 meters and the low pressure is at least less than about 0.85 bar.
